(19) United States
(12) Patent Application Publication
(10) Pub. No.: US 2011/0061982 A1
(43) Pub. Date: Mar. 17, 2011

(54) IMPROVED STRUCTURE OF SINGLE-PULL COMPOSITE WIRE REEL

(76) Inventors: HUNG-WEN CHENG, Taipei City (TW); Yao-Cheng Lin, Taipei City (TW)

(21) Appl. No.: 12/558,606

(22) Filed: Sep. 14, 2009

(51) Int. Cl. H02G 11/02

(52) U.S. Cl. 191/12.2 R

(57) ABSTRACT

A wire reel includes a slide disk that defined centrally an internal cavity for accommodating a coil spring and an upper cavity that receives a rotation-supporting wire in a regular wound condition and also forms a circumferential cavity separated from the internal cavity and receiving a primary wire to wind therearound. A circuit board is arranged and retained between the internal cavity and the upper cavity to electrically and mechanically connect opposing inner ends of the two wires. A housing composed of mated top and bottom covers defines an interior space to rotatably receive the slide disk. The rotation-supporting wire is fixed to an underside of the top cover and is thus fixed with respect to the rotation of the slide disk. A positioning mechanism is provided between the housing and the slide disk for providing a positioning engagement therebetween for each full turn of the slide disk.

### TECHNICAL FIELD OF THE INVENTION

The present invention generally relates to a single-pull composite wire reel, aiming to provide a mechanism for one-way stretching or pulling of a composite wire comprised of a primary forward wire and a secondary spare, rotation-supporting wire, ensure mechanical strength of connection between the two wires, allow the rotation-supporting wire to be set in a from-outside-toward-inside wound condition to thereby allow the rotation-supporting wire to shrink from outside toward inside and to expand from inside toward outside for corresponding to the length of the primary wire required in extension and retraction thereof in order to significantly reduce the stretching and bending loads applied to the rotation-supporting wire and thus increasing the number of wire stretching and retracting of the wire reel and expanding the lifespan of the wire reel.

### DESCRIPTION OF THE PRIOR ART

Wire reels are commonly used in electric/electronic devices, such as computer mousse, electrical connection boxes, or multi-port USB (Universal Serial Bus) connectors for winding/retracting or releasing/stretching a wire. The wire reels of this purpose available in the market are roughly divided as one-way stretching/retracting reels and two-way stretching/retracting reels.

Simply speaking, the one-way stretching/retracting reels allow a wire to be pulled outward or stretched in a single direction. The wire reel of this type is generally structured to allow a length of a wire at one side to be extendable and/or retractable, while another length (rotation-supporting wire) of the wire at an opposite side is fixed to connect with a power supply terminal. Thus, in the one-way stretching/retracting structure of wire reels, a given length of spare wire must be provided and generally concealed inside the reel, which is the key arrangement for effective operation of wire reels of this type.

For two-way stretching/retracting reels, wires can be extended and/or retracted in generally opposite directions. The wire reel of this type is generally structured to make two wires to be synchronously stretched and/or retracted. In the course of wire extension or retraction, the wire reel is generally located midway between the two wires. Generally speaking, a wire reel of this type is used to store, in an extendable/retractable manner, an extension cable of an external device, and there is generally no spare wire needed. Thus, the two-way wire reel is different from the one-way wire reel in both structure and field and purpose of application.

Further, in the known one-way stretching/retracting wire reel, a single wire is incorporated and the reel comprises a slide disk that defines a forward circumferential chamber and a backward circumferential chamber to respectively realize the mechanisms of wire stretching and rotation supporting, so that a single wire must provide a function for both forward and backward stretching/retracting. However, the rotation supporting wire must also be moved by a distance corresponding to the length of the forward wire that has been stretched or retracted in order to support further stretching and retracting of the forward wire and to realize the single-pull operation of the wire reel.

In the above described single-pull mechanism, the wire is arranged in multi-fold bending to properly set the orientation of the wire for making a length of the wire the rotation-supporting wire. This arrangement often leads to insufficient bending and force resistance at this point. It is particularly noted in a durability test, the wire is easy to break or dislocate at this point. Further, the rotation supporting wire is provided with a winding mechanism or means to allow it to wind in a regular manner and the winding is often quite random, leading entangling, overlapping, and twisting of the wire during the course of retracting. This not only requires an increase in the stretching strength of the forward wire and also makes bending point of the rotation supporting wire weaker, leading to easy twisting, folding, and quick aging and breaking.

Thus, to provide the highest quality, the best efficient, and the greatest convenience, the present invention aims to provide a single-pull composite wire reel that overcomes the above problems.

### SUMMARY OF THE INVENTION

In view of the above described, the present invention provides a single-pull composite wire reel, which comprises a primary forward wire and a secondary rotation-supporting wire that are jointed and electrically connected to form a composite wire structure, in order to enhance the connection strength therebetween. Further, the rotation-supporting wire is set in a regular from-outside-toward-inside wound condition, so that the shrinkage and expansion of the rotation-supporting wire naturally show effort-saved operations of shrinking from outside-toward-inside and expanding from inside-toward-outside, whereby the stretching force that is applied by the primary forward wire can be reduced and the loads of stretching and bending that the rotation-supporting wire takes are lessened to thus increasing the number of wire stretching and retracting of the wire reel and expanding the lifespan of the wire reel.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a wire reel constructed in accordance with the present invention in a wound condition.

FIG. 2 is an exploded view of the wire reel of the present invention.

FIG. 3 is a top plan view of the wire reel of the present invention showing a positioning mechanism of the wire reel.

FIG. 4 is a schematic view showing connection between a secondary wire and a primary wire of the wire reel of the present invention.

FIG. 5 is a top plan view of the wire reel of the present invention with a top cover removed to show a wound condition of the secondary wire.

FIG. 6 is a cross-sectional view of the wire reel of the present invention in an assembled form.

FIG. 7 is a schematic view illustrating an application of the wire reel of the present invention to a computer mouse.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

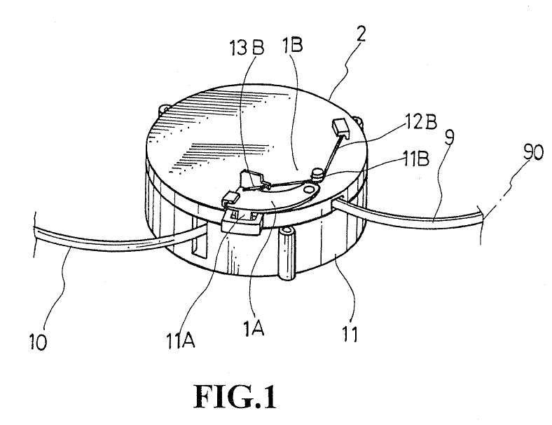

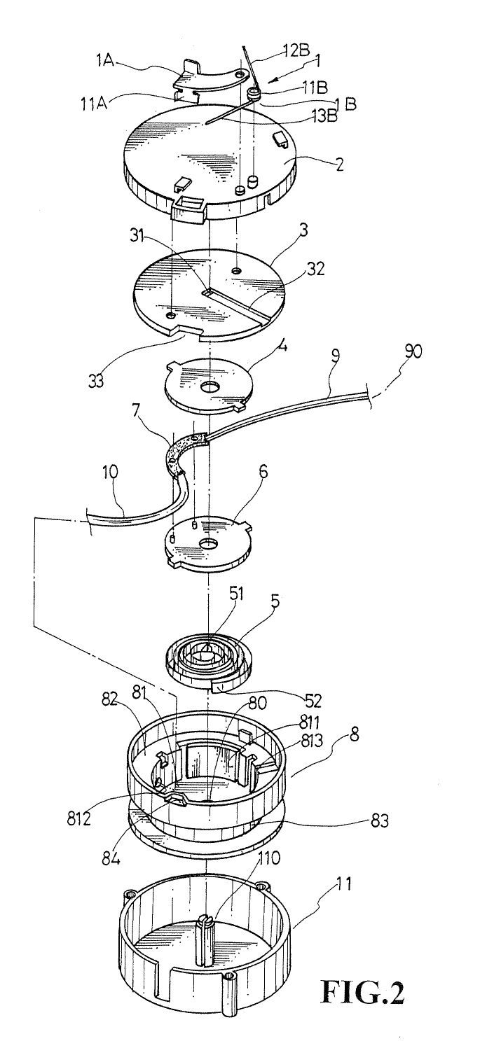

Referring to FIGS. 1 and 2, a single-pull composite wire reel constructed in accordance with the present invention comprises a positioning mechanism 1, a top cove 2, a wire fixing plate 3, an inlay lid 4, a coil spring 5, a circuit board retention plate 6, a circuit board 7, a slide disk 8, a secondary wire 9, a primary wire 10, and a bottom cover 11. The coil spring 5 is received in an internal cavity 81 defined in the slide disk 8. The coil spring 5 has a central terminal end fit into and retained by a central axle 110 formed on an inner side of the bottom cover 11 and an external terminal end forming a bend 52 that is fit into and engages a holding wall section 811 formed in the internal cavity 81, whereby the slide disk 8 is subjected to constrain imposed by the coil spring 5. Thus, rotation of the slide disk 8 in either a forward direction or a backward direction causes the slide disk 8 to be subjected to a tightening or releasing condition induced by the coil spring 5, which serves as a primary force source for winding and returning the primary wire 10.

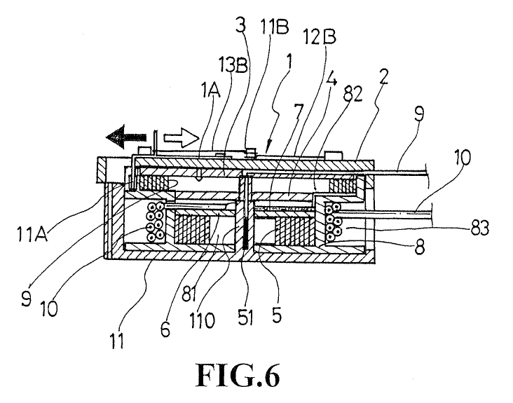

As shown in FIGS. 2 and 6, the slide disk 8 defines a central bore 80 that receives the extension of the central axle 110 and also forms therein the internal cavity 81, an upper cavity 82, and a circumferential cavity 83 for respectively receiving and accommodating the coil spring 5, the secondary wire 9, and the primary wire 10 therein. The coil spring 5 that is received in the internal cavity 81 is covered and separated by the circuit board retention plate 6 and the internal cavity 81 is further closed by the inlay lid 4 for sealing, protection, and isolation, whereby the coil spring 5, the circuit board 7, and the secondary wire 9 are accommodated inside the slide disk 8 in sequence from the inside to the outside.

The secondary wire 9 and the primary wire 10 are jointed to each other and set in electrical connection with each other by the circuit board 7, and additional arrangement can be made to joint and electrically connect the primary wire 10 and the secondary wire 9 that are of different wire gauges, as shown in FIG. 4. Further, the circuit board 7 is fixed atop the circuit board retention plate 6 to be separated from the coil spring 5 and to also provide the function of protection. The secondary wire 9 and the primary wire 10 that are jointed and electrically connected by the circuit board 7 respectively extend into the interior space of the upper cavity 82 of the slide disk and extend through a through hole 812 defined in a wall of the internal cavity of the slide disk 8 to be wound around the circumferential cavity 83 of the slide disk 8 so as to clearly define two different operation zones that allow the secondary wire 9 and the primary wire 10 to respectively carry out associated extension/retraction and stretching/returning.

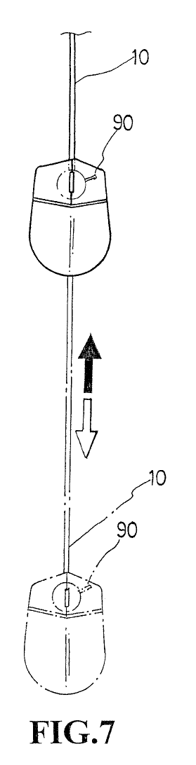

As shown in FIGS. 2 and 4, the primary wire 10 and the secondary wire 9 are jointed and electrically connected by the circuit board 7. When the primary wire 10 is pulled or stretched, due to the fact that the two wires are located in different operation zones, the primary wire 10 is completely free of dislocation or undesired dragging the secondary wire 9 into the operation zone of the primary wire 10, which prevents the primary wire 10 from being completely wound. Further, the arrangement and positional relationship of the secondary wire 9 are set with the circuit board 7 as a starting point. Due to being guided by a slot 813 defined in an inside wall of the internal cavity 81, the secondary wire 9 is allowed to extend into the upper cavity 82 of the slide disk 8 and set in a from-outside-toward-inside wound condition with a free end thereof extending through a fixing opening 31 defined in the wire fixing plate 3 at which a bend is formed to thereby allow the free end of the secondary wire 9 to extend out of the reel to serve as a power connection terminal 90 for an external device, such as a computer mouse, to which the windable wires are incorporated, as shown in FIGS. 1 and 7.

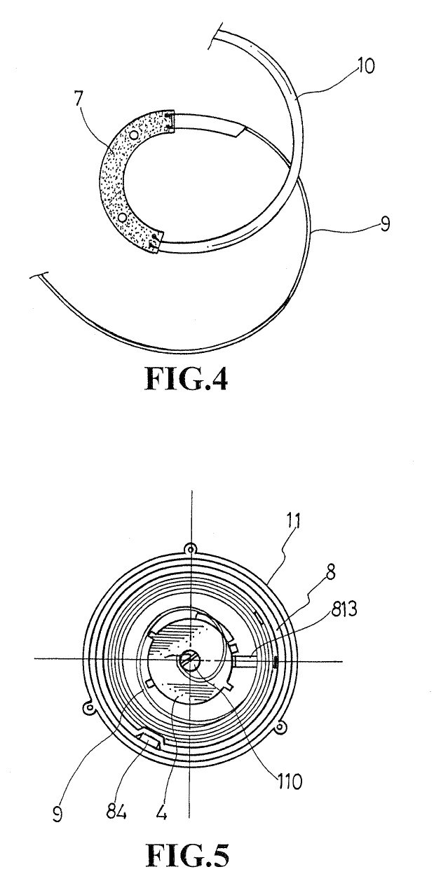

As shown in FIGS. 2 and 5, when the primary wire 10 is being stretched out, a rotational force is applied to the slide disk 8, which induces a mechanical power stored in the coil spring 5. Under this condition, the secondary wire 9 that is received in the interior space of the upper cavity 82 is caused to shrink from outside toward inside. In other words, the secondary wire 9 is shrunk inward to release a certain length for compensating the stretched length of the primary wire 10. On the other hand, when the primary wire 10 is released and returns, the coil spring 5 releases the mechanical power stored therein to rotate and return the slide disk 8. Under this situation, the secondary wire 9 is expanded from inside toward outside to resume the original loose state. The bend of the secondary wire 9 is fit to the wire fixing plate 3 fixed inside and under the top cover 2 and the fixing opening 31 and a wire receiving channel 32 defined in the wire fixing plate 3 leads the secondary wire 9 outwards, whereby the bend of the secondary wire 9 is kept stationary and is not moved with the rotation of the slide disk 8 or the secondary wire 9.

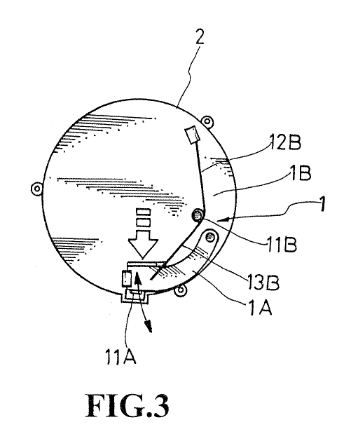

As shown in FIGS. 2, 3, and 6, the positioning mechanism 1 is set atop the top cover 2 and comprises a resilient catch plate 1A and a resilient element 1B. The resilient catch plate 1A has an end pivoted to the top cover 2 and an opposite end bent to form a pawl 11A extending into the top cover 2 and through a notch 33 defined in the wire fixing plate 3 to establish releasable engagement with an engagement recess 84 defined sideways in a top rim of the slide disk 8 located inside the top cover 2. The resilient element 1B provides a mechanical power for returning the resilient catch plate 1A after it has been displaced by forming a moment of force about a center 11B thereof, and has an end 12B that is fixed and an opposite end serving as a force application end 13B that is coupled to the resilient catch plate 1A so as to induce a resilient returning operation on the resilient catch plate 1A. Each time when the primary wire 10 is stretched outward to make a full turn of the slide disk 8, due to the engagement induced with the engagement recess 84, positioning is realized for one time. If the primary wire 10 has been stretched outward by a length to pass the engagement recess 84 of this current turn, then the positioning engagement may be realized at the next turn. In this way, multiple steps of positioning can be realized. When it needs to retract and return the primary wire 10, the resilient catch plate 1A is deformed outward to release the pawl 11A from engagement with the engagement recess 84, by which automatic rewinding and returning can be realized.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wire reel comprising a positioning mechanism, a top cove, a wire fixing plate, an inlay lid, a coil spring, a circuit board retention plate, a circuit board, a slide disk, a primary wire, a secondary wire, and a bottom cover, wherein:
the positioning mechanism is set atop the top cover and comprises a resilient catch plate and a resilient element, the resilient catch plate having an end pivoted to the top cover and an opposite end bent to form a pawl extending into the top cover to establish releasable engagement with an engagement recess defined sideways in a top rim of the slide disk located inside the top cover, the resilient element selectively providing a moment of force about a center thereof and having an end fixed and an opposite end serving as a force application end that applies a force to the resilient catch plate so as to enable resilient returning of the resilient catch plate;
the top cover is structured to allow for outward extension of the secondary wire and mates the bottom cover;
the wire fixing plate is fixed to an underside the top cover and forming a notch corresponding to the pawl, the wire fixing plate further forming a fixing opening and a wire receiving channel for leading the secondary wire outwards;
the inlay lid is received in and closes an upper cavity defined in the slide disk;
the coil spring is received in an internal cavity defined in the slide disk and has a central terminal end fit into and retained by a central axle of the bottom cover and an external terminal end forming a bend that is fit into and engages a holding wall section formed in the internal cavity so that the coil spring is retained between the central axle of the bottom cover and the slide disk;
the circuit board retention plate supports and retains the circuit board and is received in the internal cavity of the slide disk to cover the coil spring;
the circuit board is retained on the circuit board retention plate and joints and electrically connects the primary wire and the secondary wire;
the slide disk has a top rim forming the engagement recess that selectively establishes releasable engagement with the pawl of the resilient catch plate of the positioning mechanism, the slide disk defining a central bore that receives the extension of the central axle of the bottom cover and also forming the internal cavity, the upper cavity, and a circumferential cavity to respectively receives and accommodates the coil spring, the secondary wire, and the primary wire therein, the internal cavity of the slide disk having a wall defining a through hole that guides the primary wire into the circumferential cavity of the slide disk, the wall of the internal cavity also forming a slot that guides the secondary wire into the upper cavity of the slide disk, the upper cavity of the slide disk receiving the inlay lid therein for sealing and protection;
the secondary wire is electrically connected to the primary wire through the circuit board and is guided by the slot defined in the wall of the internal cavity of the slide disk into the upper cavity in which the secondary wire is set in a from-outside-toward-inside wound condition with a free end of the secondary wire extending through and retained by the fixing opening of the wire fixing plate at which a bend is formed to thereby allow the free end of the secondary wire to extend out of the reel;
the primary wire is connected to the secondary wire through the circuit board and extends through the through hole defined in the wall of the internal cavity of the slide disk to wind around the circumferential cavity of the slide disk; and
the bottom cover mates the top cover and forms the bottom cover on an inner side thereof.

2. The wire reel according to claim 1, wherein the engagement recess formed in the top rim of the slide disk establishes positioning engagement each time when the primary wire is stretched to rotate the slide disk a full turn.

3. The wire reel according to claim 1, wherein the primary wire and the secondary wire are of different wire gauges that are jointed and electrically connected by the circuit board.

4. The wire reel according to claim 1, wherein the free end of the secondary wire extending out of the reel serves as a power connection terminal and is adapted to couple to an external device and concealable inside the external device.
